(19) United States
(12) Patent Application Publication
(10) Pub. No.: US 2006/0053385 A1
(43) Pub. Date: Mar. 9, 2006

(54) Rearranging views on a computer screen

(75) Inventor: Marco Van Leeuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/542,140

(22) PCT Filed: Dec. 10, 2003
(86) PCT No.: PCT/IB03/06348

§ 371 Date: Jul. 12, 2005

(30) Foreign Application Priority Data
Jan. 15, 2003 (EP) 03075120.0

(51) Int. Cl. G06F 3/00

(52) U.S. Cl. 715/767; 715/745

(57) ABSTRACT

On a computer screen (3) various non-overlapping views (A, B, C, . . . ) or “windows” may be displayed simultaneously. To present the views more conveniently for a user, the views can be automatically rearranged in response to a single view (B) being moved by the user. Preferably, the minimum number of views is rearranged while avoiding overlap.

The present invention relates to rearranging views on the screen of a device, such as a computer. More particularly, the present invention relates to a method of rearranging views on a computer screen, as well as to a device in which the method is employed, and to a software product for carrying out the method.

It is well known to present several views simultaneously on a computer screen. In Microsoft's Windows® operating system, for example, a new view or “window” is opened for every program activated by the user. The views allow a user to interact with the particular program or to read information presented in the view. Such views are also used in hand-held devices such as PDAs (Personal Digital Assistants) and palm-top computers.

Typically, when views are created, they are assigned both dimensions and a location on the screen of the computer. The user may alter the dimensions of the view to suit his needs and may also change its location. In this way, the appearance of the view may be adapted to the needs of the user. In particular, the user may wish to arrange the views in such a way that they do not overlap. This can be achieved relatively easily by reducing the dimensions of all views until they do not overlap, and then rearrange and/or resize them in any convenient manner. Alternatively, the user or the software manufacturer may program the views in such a way that certain preferred views, when activated, automatically appear in a convenient, non-overlapping arrangement.

The resulting arrangement of non-overlapping views may not be optimal for the user, or may not remain optimal. Depending on the various applications associated with the views, the user may wish to change their relative position during his computer session. In particular, the user may want to try which arrangement of views is most convenient. However, rearranging all views manually, for example by dragging with a mouse, is inconvenient and time-consuming.

Microsoft Windows® (versions 98 and XP) has an in-built feature called “windows tiling” which allows the active views to be automatically rearranged on the screen. This, however, involves re-sizing the views to fit them on the screen. The user, however, may not want the dimensions of the views to be changed. In addition, this known feature presents only a single arrangement of the views. If the user is not satisfied with this arrangement, any rearrangement of the views has to be carried out manually.

It is therefore an object of the present invention to overcome these and other problems of the prior art and to provide a method of rearranging views on a screen which is quick and simple to use.

It is another object of the present invention to provide a software product for rearranging views on a screen, and a record carrier provided with such a software product.

Accordingly, the present invention provides a method of rearranging non-overlapping views on a computer screen, the method comprising the steps of:

the computer receiving a request from a user to move a selected view to a new location on the screen,

the computer determining, in response to the request, an alternative arrangement of the views with the selected view at its new location, and

the computer displaying the alternative arrangement on the screen.

That is, the computer automatically determines, upon receipt of a request from the user to move a particular view, an alternative non-overlapping arrangement of the original views and displays this arrangement. In this arrangement, the particular view which the user requested to be moved has been moved to the position indicated by the user.

The user can make the request to move a view in a conventional manner, such as by selecting and “dragging” a particular view, using a pointing device such as a mouse or a touch-pad. When the user has finished “dragging” the view across the screen, the request is completed and the (approximate) desired end position of the view is determined by the computer. The computer may adjust this approximate position to better fit this view and the other views on the screen, for instance by moving the view closer to an edge of the screen. The computer then attempts to determine an alternative arrangement of the views with the particular view in the position as requested.

Alternatively, the new location is determined by a direction specified by the user and a number of predetermined steps. That is, the user can indicate a direction in which the view is to be moved, using, for example, cursor (arrow) keys. The computer then moves the view one or more predetermined steps. The number of steps may, for example, depend on the number of key activations or the duration of a key activation.

If no alternative arrangement of the views is available, it is preferred that the original arrangement is displayed. Although it would be possible to resize the individual views, it is preferred that the views retain their original dimensions, that is, only their positions are changed.

In a preferred embodiment, the views retain their relative positions to the largest extent possible. That is, when the selected view has been moved, the other views retain their relative positions and are preferably moved in block of views, alternatively in as few blocks as possible, each block containing two or more views. This results in a rearrangement having as few changes as possible, thus making it easier for the user to evaluate the result of the rearrangement.

The present invention additionally provides a device, such as a computer, programmed to carry out the method defined above. The present invention further provides a software product for carrying out the method defined above, as well as a record carrier, such as a floppy disk, DVD or CD-ROM, provided with such a software product.

The present invention will be further explained below with reference to examples of embodiments illustrated in the accompanying drawings, in which:

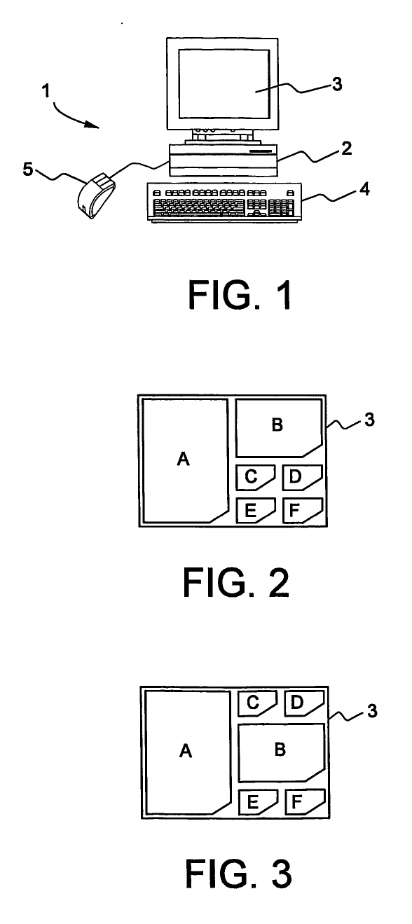

FIG. 1 schematically shows a computer system in which the present invention may be utilized.

FIG. 2 schematically shows a first arrangement of views on a computer screen.

FIG. 3 schematically shows a second arrangement of views on a computer screen.

The computer system 1 shown merely by way of non-limiting example in FIG. 1 comprises a computer unit 2 connected to a display screen 3, a keyboard 4 and a mouse 5. The computer unit 2 executes various software programs, including an operating system having a graphical user interface such as Microsoft Windows( or operating systems marketed by Apple Computer Inc. The computer unit 2 also executes a software program for carrying out the method of the present invention, as well as several other software programs. Although a desktop computer system is shown in FIG. 1, the present invention is not limited thereto and is equally applicable to laptop computers, palmtop computers, PDAs (Personal Digital Assistants), electronic organizers, etc.

Several views are displayed on the screen 3 of the computer system 1, each view corresponding to an active software program or an object, such as a photo. FIG. 2 schematically shows, by way of example only, an original arrangement of the views, as arranged on the screen by the operating system or by the user. A first view A is approximately half the size of the screen (3 in FIG. 1), while a second view B is approximately a quarter of the size of the screen. Views C, D, E and F are each one-sixteenth the size of the screen. It will be understood that these dimensions are given by way of example only and that, in principle, the views could have any dimensions which would allow them to fit on the screen and to avoid overlap.

The user may decide that the view of FIG. 2 is not ideal and may wish to change the view. Instead of manually dragging the individual views to other locations on the screen using a mouse, touch pad or other pointing device, while avoiding overlap, the present invention allows the computer to present an alternative arrangement of views by dragging only a single view to a new location on the screen.

Accordingly, the user may select a particular view in a conventional manner, for example, by clicking on the view using a pointing device, such as a mouse. The user then “drags” the selected view across the screen to its new position. Once the user has finished dragging the view and has “let go” of the view, as is the case when a pointing device such as a mouse is used, the computer may adjust the new position of the view as may be necessary to correctly fit the view on the screen. Such an adjustment will typically be minor in comparison with the movement of the view across the screen as effected by the user.

Alternatively, the user may indicate a direction in which a selected view is to be moved by using keys such as cursor (arrow) keys, a joystick, a touch pad, a voice command, a gesture or any other type of input. The computer may then attempt to move the view in the direction indicated. The view is first moved over one position, that is, the view takes up the first position possible when moved in the indicated direction. The computer will attempt to rearrange the views and to display the rearranged views if such a rearrangement is possible. If no rearrangement is possible, the original arrangement is displayed. Alternatively, the computer may move the view in the indicated direction over another position until such a rearrangement is possible.

If, after moving the view over one position, the user still indicates a direction (for example by still pressing a key), the view is moved over another position and the above procedure is repeated. When the user ceases to indicate a direction, or when the view reaches the edge of the screen, the view remains in its last position, provided that a rearrangement of the views is possible for this position. If such a rearrangement is not possible in this position, the view is returned to the last position in which a rearrangement was possible.

In the present invention, this repositioning of a selected view constitutes a request to rearrange the remaining views. The computer or, strictly speaking, the software program being executed by the computer, determines an alternative arrangement in response to this request. This is preferably done when the user has completed moving the view across the screen. It is, however, possible for the computer to determine an alternative arrangement during the movement of the view, for example, after each step in the stepwise movement indicated above.

In the example of FIGS. 2 and 3, the user moves view B down over a distance equaling approximately one-quarter of the screen height. In the arrangement of FIG. 2, this causes an overlap with views C and D. According to the present invention, a rearrangement is produced in which this overlap is removed.

A preferred rearrangement is shown in FIG. 3, where the computer has moved views C and D from below view B to above view B in response to the user moving view B. In the arrangement of FIG. 3, any overlap has been removed. It is noted that this has been accomplished without the computer moving views A, E and F. It would also have been possible for the computer to move views E and F to a position above view B and moving views C and D further down. Moving views C and D, however, has the advantage of moving the minimum number of views, and of retaining the views in their original relative positions to the greatest extent possible. This in turn makes it easier for the user to recognize the views and to evaluate the result of the rearrangement. It is further noted that all views have retained their original dimensions.

Determining an alternative arrangement can be carried out in a number of ways. The actual algorithm employed is not essential to the present invention, but an example will be given to further illustrate the application of the present invention.

When view B is moved down from the position shown in FIG. 2 to the position shown in FIG. 3, it overlaps views C and D. The algorithm detects this overlap, for example by comparing the co-ordinates of the corners of the views. The algorithm then attempts to find empty locations which are large enough to accommodate views C and D. These empty locations are found above view B, and views C and D are subsequently moved to these locations. As no further overlap is detected, the rearrangement is complete.

The new arrangement of the views may be stored and the software program may automatically generate this arrangement the next time the user logs on to the computer system.

Of course, the method of the present invention may be repeated as often as desired. By moving views back to their original positions, the original arrangement can be restored. In an advantageous embodiment, the original arrangement is stored so as to be able to undo all rearrangements. To thus restore the original arrangement, a suitable software button or similar input mechanism may be activated. In an embodiment of the present invention, therefore, a software button or menu option “restore” appears once the first rearrangement has been effected.

A software program for carrying out the method of the present invention may be a separate utility program or may be integrated into the operating system. The software program may be stored on a machine-readable record carrier, such as a floppy disk, a CD-ROM, a zip-disk, a DVD and the like.

The present invention is based upon the insight that all views displayed on a computer screen may be rearranged by the computer in response to the user repositioning a single view. The present invention benefits from the further insight that any overlap of views is to be avoided if views are to be used effectively.

It is noted that any terms used in this document should not be construed so as to limit the scope of the present invention. In particular, use of the verb “comprise” and its conjugations is not meant to exclude any elements not specifically stated. Single (circuit) elements may be substituted for multiple (circuit) elements or their equivalents. In addition, the word “computer” as used in this document is not limited to desktop computers but is also meant to encompass laptop computers, palmtop computers, PDAs, electronic organizers and other electronic devices comprising a screen and a processor.

It will therefore be understood by those skilled in the art that the present invention is not limited to the embodiments illustrated above and that many modifications and additions may be made without departing from the scope of the invention as defined in the appending claims.

1. A method of rearranging non-overlapping views on a computer screen (3), the method comprising the steps of:
the computer receiving a request from a user to move a selected view (B) to a new location on the screen,
the computer determining, in response to the request, an alternative arrangement of the views (A, B, C, D, E, F) with the selected view (B) at its new location, and
the computer displaying the alternative arrangement on the screen.

2. The method as claimed in claim 1, wherein the views retain their original dimensions.

3. The method as claimed in claim 1, wherein the new location is determined by a direction specified by the user, the computer preferably moving the selected view in said direction until an alternative arrangement is found.

4. The method as claimed in claim 1, wherein, if no alternative arrangement of the views is available, the original arrangement is displayed.

5. The method as claimed in claim 1, wherein the views not selected by the user retain their relative positions to the largest extent possible.

6. The method as claimed in claim 1, wherein the original arrangement is stored and can be recreated upon request.

7. A device programmed to carry out the method as claimed in claim 1.

8. The device as claimed in claim 7, which is a desktop computer (1), a laptop computer, a palmtop computer, a PDA or an electronic organizer.

9. A software product for carrying out the method as claimed in claim 1.

10. A record carrier, such as a CD-ROM, provided with a software product as claimed in to claim 9.
